(19) United States
(12) Patent Application Publication
(10) Pub. No.: US 2020/0031320 A1
(43) Pub. Date: Jan. 30, 2020

(54) WHEEL WASHING APPARATUS AND METHOD FOR CLEANING A WHEEL AND VEHICLE CLEANING INSTALLATION

(71) Applicant: Alfred Kärcher SE & Co. KG, Winnenden (DE)

(72) Inventors: Claus Heid, Stuttgart (DE); Johannes Doebele, Hessigheim (DE); Michael Heinze, Hemmingen (DE)

(21) Appl. No.: 16/590,708

(22) Filed: Oct. 2, 2019

Related U.S. Application Data
(63) Continuation of application No. PCT/EP2017/058389, filed on Apr. 7, 2017.

(51) Int. Cl. B60S 3/04; B60S 3/06

(52) U.S. Cl. CPC B60S 3/042; B60S 3/06

(57) ABSTRACT

The present invention relates to a wheel washing apparatus for cleaning a wheel of a motor vehicle, comprising a brush device which includes or forms at least one brush that is placeable against the wheel, a drive device for rotatingly driving the at least one brush, and an advancing device with which the brush device is transferable from a rest position remote from the wheel into at least one use position near the wheel, wherein the brush device is lowerable by means of the advancing device upon moving in the direction of the wheel, wherein the brush device is moveable by means of the advancing device along a trajectory having at least one inflection point upon moving from the rest position into the at least one use position. The invention also relates to a vehicle washing installation and a method for cleaning a wheel.

### CROSS-REFERENCE TO RELATED APPLICATIONS

This application is a continuation patent application of international application number PCT/EP2017/058389, filed on Apr. 7, 2017, which is incorporated herein by reference in its entirety and for all purposes.

### FIELD OF THE INVENTION

The present invention relates to a wheel washing apparatus for cleaning a wheel of a motor vehicle, comprising a brush device which comprises or forms at least one brush that is placeable against the wheel, a drive device for rotatingly driving the at least one brush, and an advancing device with which the brush device is transferable from a rest position remote from the wheel into at least one use position near the wheel, wherein the brush device is lowerable by means of the advancing device upon moving in the direction of the wheel.

The present invention also relates to a method for cleaning a wheel.

Furthermore, the present invention relates to a vehicle washing installation comprising at least one wheel washing apparatus for cleaning a wheel. The vehicle washing installation may be a gantry-type washing installation, which travels relative to a stationary vehicle. Alternatively, the vehicle washing installation may be a conveying washing installation in which the vehicle to be cleaned is moved by means of a conveying device.

### BACKGROUND OF THE INVENTION

In a wheel washing apparatus of the kind stated at the outset, the brush device may be moved by means of the advancing device from a rest position remote from the wheel in the direction of the wheel. In a use position near the wheel, cleaning elements of the at least one brush, in particular cleaning bristles, can contact the wheel. By means of the drive of the drive device, the wheel is cleaned, in particular in the region of the wheel rim. The brush device may then be transferred again from the use position into the rest position by means of the advancing device.

Apart from a few exceptions (for example relatively wide, but flat sports cars), motor vehicles typically have larger diameter wheels, the wider the motor vehicles are. Correspondingly, small cars are narrow and comprise wheels of a rather small diameter. Compact class or mid-sized vehicles are wider and comprise larger diameter wheels in relation to small cars. Luxury vehicles, in particular large SUVs, are even wider and comprise even larger diameter wheels. For this reason, it is known to lower the brush device by means of the advancing device upon moving in the direction of the wheel. For example, the brush device may be lowered further, the narrower the motor vehicle is, and the smaller the diameter of its wheels is. Vice versa, the brush device is lowered less in the case of a vehicle with wheels of a rather large diameter. It is understood that, presently, a correct positioning of the motor vehicle relative to the wheel washing apparatus is assumed, in particular when the wheels of the motor vehicle are acted upon from both sides at the same time with two wheel washing apparatuses.

A wheel cleaning apparatus for cleaning a wheel, in which the brush device is lowered in the direction of the wheel on an inclined plane, in relation to a horizontal supporting surface for the motor vehicle, is described in DE 1 655 989. DE 20 2008 012 139 U1 also describes a wheel washing apparatus for cleaning a wheel, in which the brush device is moved in an inclined plane and is lowered obliquely in the direction of the wheel.

U.S. Pat. No. 3,758,906 describes a wheel washing apparatus for cleaning a wheel with a brush device that is lowerable in the advancing movement. The brush device hereby performs a pendulum movement by means of an articulated parallelogram, such that the brush device is lowered in the direction of the wheel along a convex trajectory.

A brush device with a plurality of brushes is described, e.g., in WO 2012/110094 A1.

Indication of position and orientation like, for example, “up”, “down” refer presently to an intended use of the wheel washing apparatus for cleaning a wheel, which is used with a motor vehicle positioned on a supporting surface. The supporting surface is presently taken to be oriented horizontally or substantially horizontally. Ideally, the brush device is moved by means of the advancing device transversely to a longitudinal direction of the motor vehicle, i.e. the motor vehicle is preferably oriented relative to the wheel washing apparatus such that the longitudinal direction of the motor vehicle is oriented transversely and in particular perpendicularly to a plane in which the advancing movement of the brush device takes place.

An object underlying the present invention is to provide a wheel washing apparatus, a method for cleaning a wheel of a motor vehicle, and a vehicle washing installation, with which a better cleaning result can be achieved for the motor vehicles to be cleaned.

### SUMMARY OF THE INVENTION

In a first aspect of the invention, a wheel washing apparatus for cleaning a wheel of a motor vehicle comprises a brush device which comprises or forms at least one brush that is placeable against the wheel, a drive device for rotatingly driving the at least one brush, and an advancing device with which the brush device is transferable from a rest position remote from the wheel into at least one use position near the wheel. The brush device is lowerable by means of the advancing device upon moving in the direction of the wheel. The brush device is moveable by means of the advancing device along a trajectory having at least one inflection point upon moving from the rest position into the at least one use position.

In a second aspect of the invention, a vehicle washing installation, in particular gantry washing installation, is provided, comprising at least one wheel washing apparatus for cleaning a wheel in accordance with the first aspect.

In a third aspect of the invention, a method for cleaning a wheel of a motor vehicle is provided, in which a brush device, which comprises or forms at least one brush that is placeable against the wheel, is transferred by means of an advancing device from a rest position remote from the wheel into a use position near the wheel, and is thereby lowered, wherein the brush device is moved along a trajectory having at least one inflection point from the rest position into the use position.

### BRIEF DESCRIPTION OF THE DRAWINGS

The foregoing summary and the following description may be better understood in conjunction with the drawing figures, of which:

FIG. 1 shows a schematic depiction of a vehicle washing installation in accordance with the invention, comprising two wheel washing apparatuses in accordance with the invention;

FIG. 2 shows a perspective depiction of a wheel washing apparatus in accordance with the invention, the brush device of which adopts an extended use position;

FIG. 3 shows a side view of the wheel washing apparatus from FIG. 2, wherein the brush device adopts a retracted rest position, and schematically shows a wheel of a motor vehicle;

FIG. 4 shows a depiction corresponding to FIG. 3, wherein the brush device adopts an extended use position;

FIG. 5 shows an enlarged depiction according to detail A in FIG. 4;

FIG. 6 shows a depiction corresponding to FIG. 5, which shows the use of the wheel washing apparatus in the case of a larger diameter wheel of a wider of motor vehicle;

FIG. 7 shows a further embodiment of a wheel washing apparatus in accordance with the invention, the brush device of which adopts a retracted rest position, and schematically shows a wheel of a motor vehicle;

FIG. 8 shows a depiction corresponding to FIG. 7, wherein the brush device adopts an extended use position;

FIG. 9 shows an enlarged depiction according to detail B in FIG. 8;

FIG. 10 shows a depiction corresponding to FIG. 9, that shows the use of the wheel washing apparatus in the case of a larger diameter wheel of a wider motor vehicle; and

FIG. 11 shows a further embodiment of a wheel washing apparatus in accordance with the invention, the brush device of which adopts a retracted rest position, and schematically shows a wheel of a motor vehicle.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a wheel washing apparatus for cleaning a wheel of a motor vehicle, comprising a brush device which comprises or forms at least one brush that is placeable against the wheel, a drive device for rotatingly driving the at least one brush, and an advancing device with which the brush device is transferable from a rest position remote from the wheel into at least one use position near the wheel. The brush device is lowerable by means of the advancing device upon moving in the direction of the wheel. The brush device is moveable by means of the advancing device along a trajectory having at least one inflection point upon moving from the rest position into the at least one use position.

In the wheel washing apparatus in accordance with the invention, the advancing device is configured such that during the advancing movement, the brush device can travel a trajectory that has at least one inflection point. The curvature of the trajectory changes at the inflection point. The advancing movement of the brush device therefore takes place, unlike in the above-mentioned publications DE 1 655 989 and DE 20 2008 012 139 U1, not along a continuously inclined, rectilinear movement of the brush device. Instead, the brush device changes the direction of movement at at least one inflection point in the trajectory, wherein, in contrast to U.S. Pat. No. 3,758,906 stated at the outset, the curvature of the trajectory changes at least once. For example, the trajectory, commencing from the rest position, is initially curved in the direction of the supporting surface for the motor vehicle, and after an inflection point, the trajectory changes in such a way that the trajectory is curved away from the supporting surface. It has shown in practice that the movement of the brush device along the trajectory with at least one inflection point delivers the best match with the conditions when one considers the diameter of the wheels in relation to the width of the motor vehicles in the overwhelming majority of motor vehicles. This shows, for example, that the diameter does not increase proportionally to the width. The wheels are, indeed, typically larger, the wider the motor vehicles are, the ratio of the diameter to the width initially increasing. However, the ratio of the diameter to the width reduces again with increasing width of the motor vehicles. It therefore shows that when traversing a trajectory that has at least one inflection point, a significantly higher probability exists that the brush device is thus positioned on the wheel in the correct position, such that an axis of the brush device abuts as close as possible to the wheel axis and ideally coincides therewith. The coverage of the rotating brush(es) on the wheel is increased in comparison to conventional wheel washing apparatuses, and the cleaning result is thereby improved.

It is understood that the brush device, depending on the width of the motor vehicle to be cleaned, is typically moved only along a section of the trajectory. In some circumstances, with a relatively wide vehicle, a movement takes place commencing from the rest position not even up to the at least one inflection point of the trajectory.

It proves to be advantageous if the brush device is moveable along a trajectory having exactly one inflection point.

It is favorable if the at least one inflection point is arranged in the middle or substantially in the middle between the rest position and a maximally extended use position of the brush device in relation to the rest position. Commencing from the rest position, the brush device may be transferred into a plurality of use positions, wherein the respective use position is determined by the width of the motor vehicle and the position of the wheel dependent thereon. In the respective use position, the brushes abut against the wheel with cleaning elements. The brush device may thus be transferred from the rest position into a maximally extended use position in relation to said rest position. The at least one inflection point and in particular exactly one inflection point is advantageously located in the middle or substantially in the middle between the maximally extended use position and the rest position.

It proves to be advantageous if the brush device is moveable along an arcuate trajectory commencing from the rest position to the at least one inflection point. The brush device thereby advantageously travels along an arc, curved in the direction of the supporting surface, with a concave trajectory.

It is favorable if the brush device is moveable along an arcuate trajectory commencing from the at least one inflection point to a use position of the brush device that is maximally extended in relation to the rest position. The brush device is thereby advantageously moved along an arc, curved away from the supporting surface, with a convex trajectory.

For example, the brush device is moveable along a trajectory that is substantially point-symmetrical in relation to the at least one inflection point.

It proves to be favorable if the brush device is moveable along a trajectory that is approximately cosine-shaped commencing from the rest position. The trajectory may initially be curved arcuately in the direction of the supporting surface. The curvature of the trajectory changes at the inflection point in such a way that it is curved arcuately away from the supporting surface.

In an advantageous embodiment of the wheel washing apparatus in accordance with the invention, provision may be made for the brush device, upon moving commencing from the rest position, to be moveable in parallel or substantially in parallel to a supporting surface for the motor vehicle. The brush device may therefore be moved initially in parallel or substantially in parallel to the supporting surface. This may correspond in particular to a horizontal or substantially horizontal movement.

Correspondingly, it is advantageous if the brush device, when transferring into a maximally extended use position in relation to the rest position, is moveable in parallel or substantially in parallel (in particular horizontally or substantially horizontally) to a supporting surface for the motor vehicle.

The two aforementioned advantageous embodiments may be summarized in that the trajectory advantageously runs in parallel or substantially in parallel at the start and at the end (with the brush device maximally extended).

It proves to be favorable if the brush device is moveable in a plane oriented perpendicularly or substantially perpendicularly to a supporting surface for the motor vehicle. This is, in particular, a vertical or substantially vertical plane.

The advancing device advantageously comprises a holding device on which the brush device is fixed, and a displacement device coupled to the holding device for transferring the brush device from the rest position into the at least one use position. The displacement device may engage on the holding device in order to move and/or to deform the same with the brush device held thereon. In both cases, the brush device may be moved as a result. The displacement device may engage on the holding device with both effective ends. It is also conceivable for the displacement device to engage on the holding device with a first effective end, and to engage on a support device with a second effective end, by way of which support device the wheel washing apparatus in accordance with the invention stands on the supporting surface for the motor vehicle.

The support device may be a washing gantry of a vehicle washing installation comprising the wheel washing apparatus.

The displacement device may, for example, be of electrical, mechanical, pneumatic, and/or hydraulic configuration. A control device may be provided for controlling the displacement device.

In an advantageous embodiment, the displacement device may comprise or form at least one piston-cylinder unit. By changing the length of the piston-cylinder unit, the holding device can be moved or deformed, the brush device thereby being advanced.

It is favorable if the advancing device comprises a guide device for guiding the movement of the brush device. A reliable movement of the brush device during the advancement along the intended trajectory may thereby be ensured.

In an advantageous embodiment of the wheel washing apparatus in accordance with the invention, the guide device may comprise at least one guide rail, into which at least one guide member of the holding device engages, the course of which defines the trajectory. The holding device may comprise one or more guide members, which engage into the guide rail. When the holding device is moved by means of the displacement device, the guide rail serves to guide the holding device, the brush device thereby being moved along the trajectory. A plurality of guide rails may be provided, the holding device thereby engaging with at least one guide member into a respective guide rail. Alternatively or in addition, it is conceivable for the holding device to engage with two or more guide members into a guide rail.

An advantageous embodiment of the wheel washing apparatus in accordance with the invention makes provision for two guide rails arranged at a distance from each other to be provided, between which the holding device is arranged. The holding device may thereby be supported on both sides in the guide rails, and thereby be reliably guided. This ensures a movement or deformation of the holding device that is free of tilting.

In an advantageous embodiment of the wheel washing apparatus in accordance with the invention, provision is made for the holding device to comprise or form the guide device.

In an advantageous embodiment, it is favorable if the guide device comprises at least one joint arrangement with joint members which are pivotable relative to each other and on which the brush device is directly or indirectly fixed by way of a holding part of the holding device. The brush device may be fixed on the joint members directly or indirectly, by means of a holding part of the holding device. The joint arrangement may be fixed directly or indirectly, for instance by means of a holding part of the holding device, on a support device for the wheel washing apparatus on a side opposite the brush device. The displacement device may engage on at least one joint member and thereby pivot the joint members relative to each other in this way, in order to transfer the brush device from the rest position into the at least one use position.

Optionally, in a wheel washing apparatus of the kind stated at the outset, which comprises a holding device and a displacement device, it is favorable if the guide device comprises at least one joint arrangement with joint members which are pivotable relative to each other and on which the brush device is directly or indirectly fixed by way of a holding part of the holding device. A wheel washing apparatus of that kind for cleaning a wheel may constitute an independent invention. It is hereby possible to move the brush device along a trajectory when transferring from the rest position into the at least one use position, which trajectory does not necessarily need to have at least one inflection point. For example, a rectilinear movement of the brush device could be carried out, in which the brush device is lowerable in the direction of the wheel during the advancing movement. The joint arrangement may advantageously comprise or form at least one scissor joint, the legs of which are the joint members. A holding device and at least one displacement device as explained above is hereby provided. Legs of the scissor joint(s) may be articulated on holding parts of the holding device, wherein the brush device is fixed on a holding part, and the other holding part is fixed on the support device.

Joint members of the joint arrangement that are pivotably connected to each other advantageously define joints with respective joint axes running in parallel to each other. The joint axes are advantageously oriented in parallel or substantially in parallel to a supporting surface for the motor vehicle.

It is favorable if the joint arrangement comprises or forms at least one scissor joint, the legs of which are the joint members. By way of the scissor joint, the brush device may be transferred from the retracted rest position into the at least one extended use position in a simple and functionally reliable manner. In the rest position, the wheel washing apparatus takes up only relatively little installation space as a result of the scissor joint.

It is favorable if two or more scissor joints arranged in series are present. By means of a “scissor track assembly” of that kind, it is possible to extend the brush device relatively far, wherein at the same time, the wheel washing apparatus in the rest position of the brush device takes up particularly little installation space.

It is favorable if the joint arrangement comprises a joint member which is articulatedly connected to one of the legs of the scissor joint and to the brush device or the holding part on which the brush device is fixed. The joint member is accordingly articulated on one of the legs and on the brush device or on the holding part. As a result of the joint member, it may be ensured that the brush device is not moved rectilinearly by means of the scissor joint, but rather arcuately.

In a corresponding manner, it is advantageous if the joint arrangement comprises a joint member which is articulatedly connected to one of the legs and to a holding part of the holding device, by way of which holding part the holding device is fixed on a support device for placing the wheel washing apparatus on a supporting surface for the motor vehicle. The joint member is articulated on the leg of the scissor joint and on the holding part. It is thereby ensured that the brush device is not moved rectilinearly during travel by means of the scissor joint, but rather arcuately.

The support device may be a washing gantry or a part thereof, for example. The support device may be stationary or travel relative to the motor vehicle.

It proves to be advantageous if two joint arrangements arranged at a distance from each other are provided, between which the displacement device and/or the drive device for the brush device is arranged. As a result of two joint arrangements, a more robust construction of the wheel washing apparatus and a more reliable advancement of the brush device is made possible. The installation space between the joint arrangements is favorably used for the displacement device and/or the drive device, in order to achieve a compact design.

The joint arrangements are advantageously of functionally identical configuration, wherein mutually corresponding joint members of the joint arrangements are connected to each other by a connecting member. The joint arrangements may thereby be given a rigid, robust construction. Joint members of the joint arrangements including the connecting member have, for example, a bracket-shaped, U-shaped form.

The joint arrangement also enables a relatively lightweight construction of the wheel washing apparatus.

Provision may be made for the displacement device to be directly or indirectly coupled to at least one joint member of the at least one joint arrangement. By means of the displacement device, for example the piston-cylinder unit, a joint member may thereby be acted upon for deforming the joint arrangement. In one embodiment, provision may be made for the displacement device to engage directly on a joint member. In an embodiment of another kind, a coupling member is provided for coupling to the joint member.

For example, a bracket-shaped coupling member is provided, which is articulated on joint members of the two joint arrangements. If, as mentioned above, two joint arrangements are present, the displacement device advantageously engages on both joint arrangements by way of the bracket-shaped coupling member. Separate displacement devices may thus be saved. At the same time, a reliable functioning of the advancing device is ensured.

The advancing device advantageously comprises at least one restoring element which acts counter to the action of the displacement device and which serves to transfer the brush device in the at least one use position into the rest position, or at least supports this transfer. For example, the at least one restoring element in the form of a spring element engages on legs of the at least one scissor joint.

The at least one restoring element is advantageously configured as a spring element, for example as a coil spring.

It is advantageous if the at least one restoring element is arranged between the joint arrangements. As a result, a compact design of the wheel washing apparatus may be achieved.

The at least one restoring element advantageously biases joint members of the at least one joint arrangement relative to each other in the direction of the rest position of the brush device.

In a different kind of advantageous embodiment of the wheel washing apparatus in accordance with the invention, the displacement device has two drive units for moving the holding device in two directions oriented at an angle to each other, wherein the movement of the brush device along the trajectory is controllable by controlling the drive units. By means of the two drive units, which, e.g., may be controlled by a common control device, the brush device may be moved along the trajectory in a targeted manner. It is advantageously possible, should it be necessary, to modify the trajectory by means of appropriate control.

The two directions are advantageously oriented perpendicularly or substantially perpendicularly to each other.

For example, the directions are oriented in parallel and perpendicularly to a supporting surface for the motor vehicle, in particular horizontally and vertically.

The drive device is advantageously fixed on the holding device. As a result, a compact design of the wheel washing apparatus may be achieved. For example, the holding device is fixed on the aforementioned holding part of the holding device on which the brush device is fixed. The brush device and the drive device are preferably arranged on mutually averted sides of the holding part.

The brush device may have a distribution device for a cleaning liquid. For example, at least one nozzle is provided for spraying a cleaning liquid, in particular water. The cleaning effect of the wheel cleaning apparatus may thereby be increased.

A supply conduit for cleaning liquid is advantageously held on the holding device. The supply conduit is connected, for example, to the brush device for applying the cleaning liquid to the distribution device.

As already mentioned, the present invention also relates to a vehicle washing installation. A vehicle washing installation in accordance with the invention comprises at least one wheel washing apparatus for cleaning a wheel of the kind stated above.

The vehicle washing installation may be a gantry washing installation or a conveying washing installation.

As also mentioned, the present invention also relates to a method. A method in accordance with the invention, which achieves the object stated at the outset, for cleaning a wheel of a motor vehicle is characterized in that a brush device, which comprises or forms at least one brush that is placeable against the wheel, is transferred by means of an advancing device from a rest position remote from the wheel into a use position near the wheel, and is thereby lowered. The brush device is moved from the rest position into the use position along a trajectory having at least one inflection point.

The advantages that can be achieved with the wheel washing apparatus in accordance with the invention can also be achieved in the vehicle washing installation and in performing the method. To avoid repetition, reference may be made to the preceding remarks in this regard.

Advantageous embodiments of the vehicle washing installation in accordance with the invention and advantageous embodiments of the method in accordance with the invention result from advantageous embodiments of the wheel washing apparatus in accordance with the invention. Reference may be made likewise to the preceding remarks in this regard.

The embodiments of the wheel washing apparatus explained in the following make it possible to perform advantageous embodiments of the method.

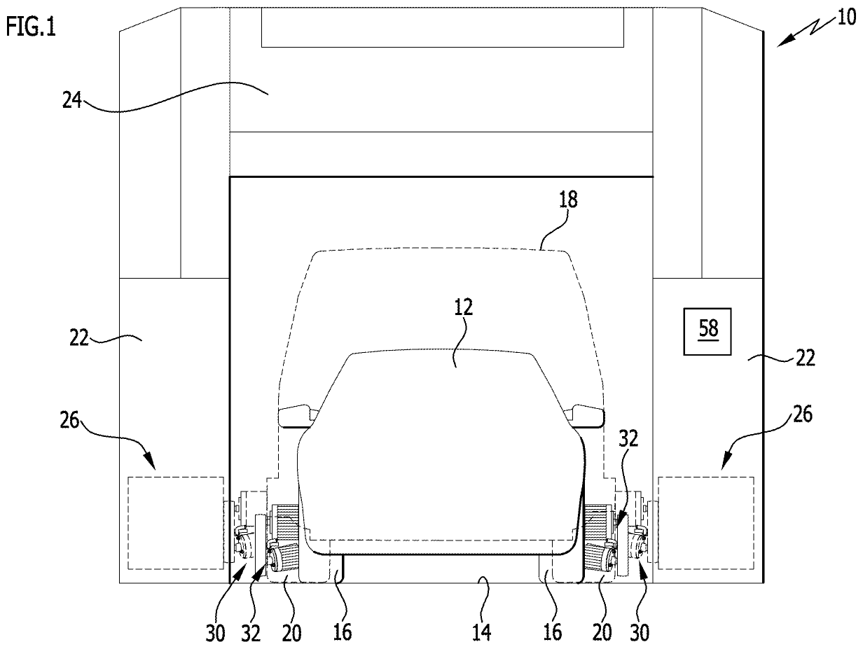

FIG. 1 shows schematically a preferred embodiment of a vehicle washing installation in accordance with the invention, designated with the reference numeral 10. The vehicle washing installation 10 is presently configured as a gantry washing installation, which can travel relative to a motor vehicle 12 along a direction of travel oriented perpendicularly to the drawing plane. The motor vehicle 12 is positioned on a supporting surface 14 and is oriented with its longitudinal direction along the direction of travel of the vehicle washing installation 10. The supporting surface 14 is presently taken to be oriented horizontally.

For placing on the supporting surface 14, the motor vehicle 12 comprises wheels 16 which may be cleaned by means of the wheel washing apparatus in accordance with the invention described below.

Furthermore, FIG. 1 shows a further motor vehicle 18 which is larger than the motor vehicle 12. For example, the motor vehicle 12 is a compact class car and the motor vehicle 18 is an SUV. The motor vehicle 18 comprises, for its part, wheels 20 for placing on the supporting surface 14, which wheels 20 have a greater diameter than the wheels 16 of the motor vehicle 12. Moreover, the motor vehicle 18 is wider than the motor vehicle 12.

It is assumed that the motor vehicle 12, 18 is positioned relative to the vehicle washing installation 10 in the correct way as intended, and that said motor vehicle is located substantially in the middle between supports 22 of the washing gantry. The supports 22 are oriented vertically and, for example, are connected to each other by means of a transverse support 24.

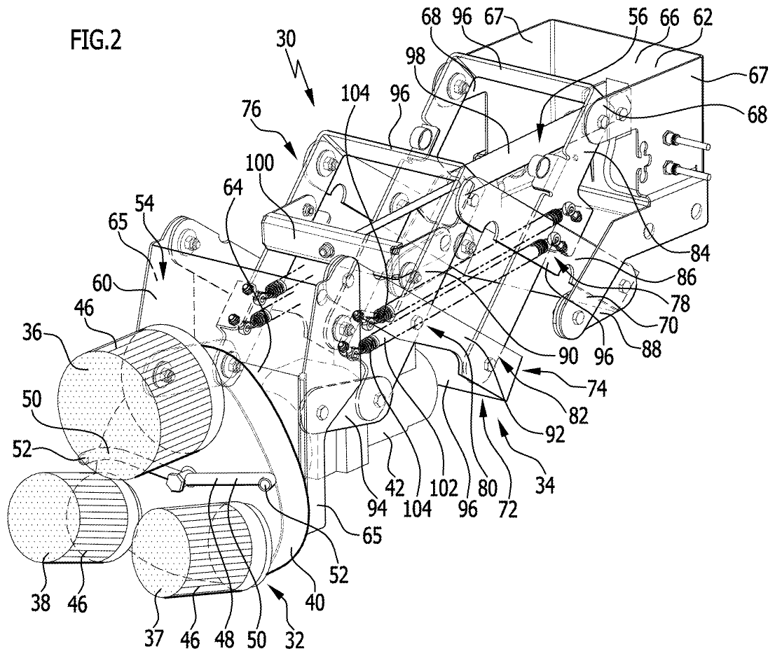

The supports 22 each form a support device 26 for an advantageous embodiment of a wheel washing apparatus in accordance with the invention, designated with the reference numeral 30. Held on each support 22 is a wheel washing apparatus 30, and sits therewith indirectly on the supporting surface 14, relative to which the wheel washing apparatus 30 may be moved by the washing gantry traveling. The wheel washing apparatuses 30 are of functionally identical configuration, such that in the following, only one of the wheel washing apparatuses 30, the wheel washing apparatus depicted on the right in FIG. 1, is explained in the following with reference to FIGS. 2 to 6. The following remarks apply correspondingly for the other wheel washing apparatus depicted on the left in FIG. 1.

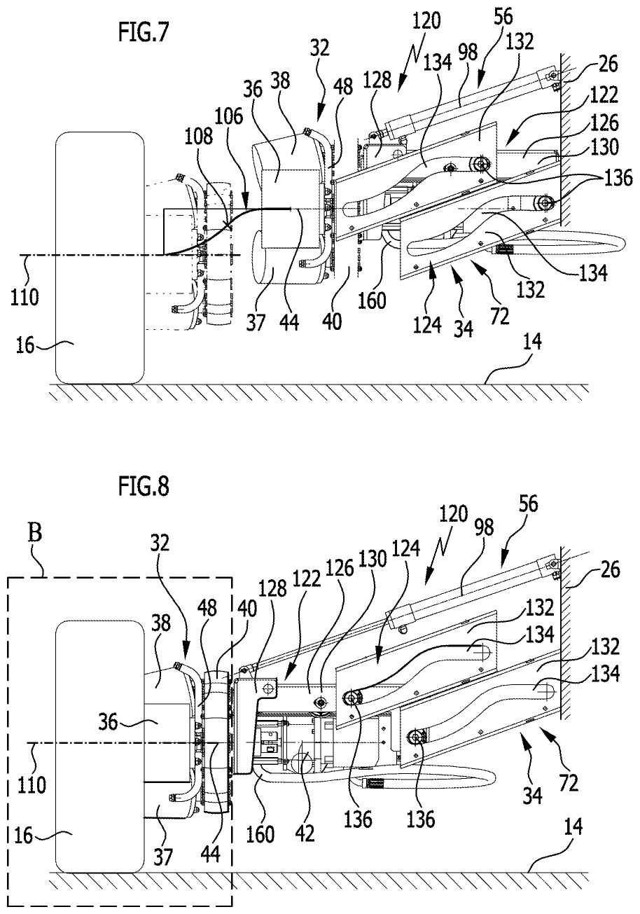

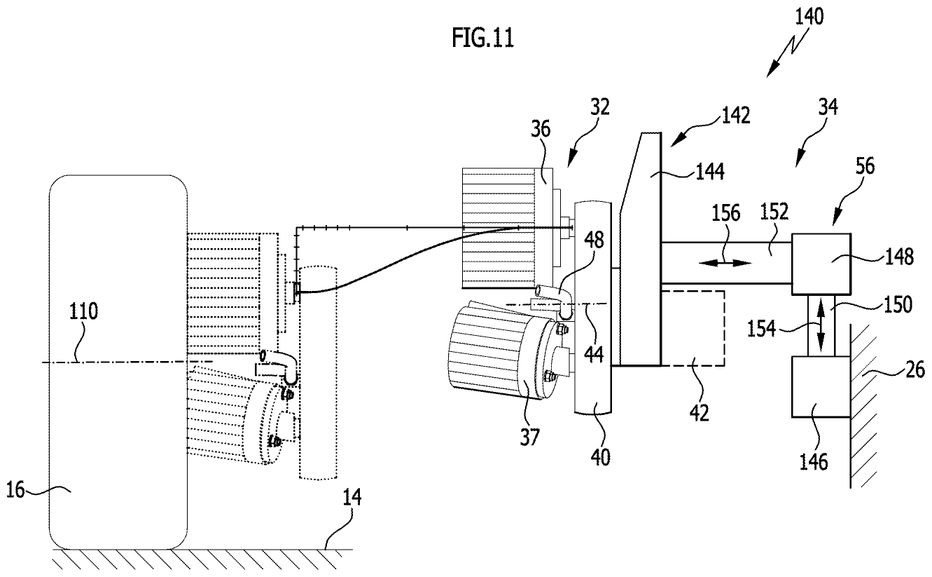

The same applies to the embodiment of a wheel washing apparatus in accordance with the invention, explained below with reference to FIGS. 7 to 10, and to the advantageous embodiment of the invention explained of a wheel washing apparatus in accordance with the invention, explained with reference to FIG. 11.

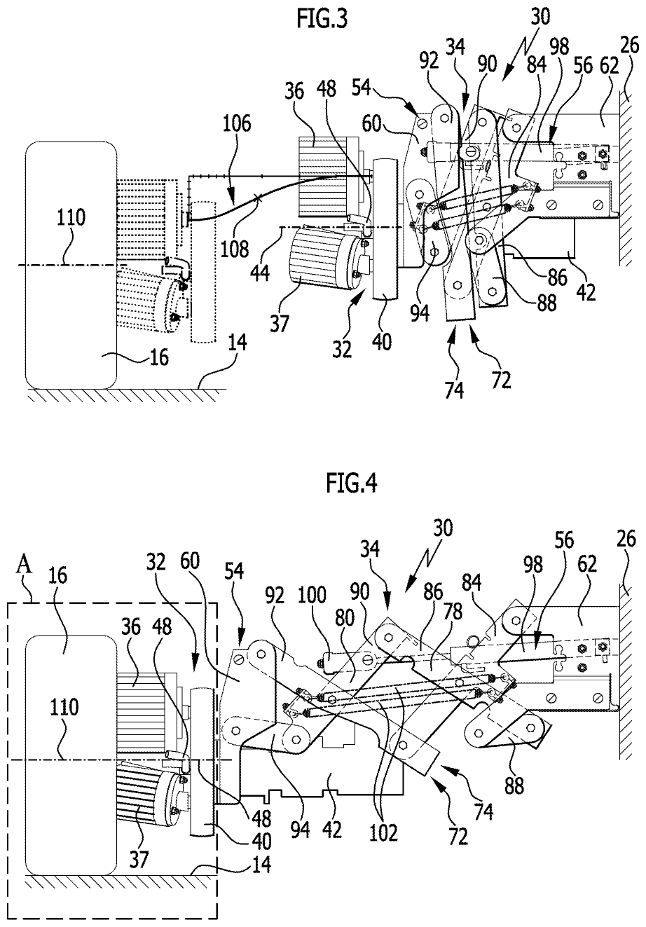

The wheel washing apparatus 30 in accordance with the invention comprises a brush device 32 and an advancing device 34 in order to transfer the brush device 32 from a rest position remote from the wheel (FIG. 3) into at least one use position near the wheel (FIG. 4) and vice versa.

The brush device 32 may be configured differently, for example at least one brush is provided for placing against the wheel 16. The at least one brush may comprise cleaning elements, in particular in the form of cleaning bristles.

The brush device 32 presently comprises three brushes 36, 37, 38, which are held on a brush support 40. The brush support 40 forms a housing in which a gearing (not shown), driven by a drive device 42 for the brush device 32, is accommodated. The structure of the gearing and the mounts of the brushes 36, 37, 38, and their configuration in detail may vary, for example as in WO 2012/110094 A1 mentioned at the outset. In the wheel washing apparatus 30, it is possible to rotatingly drive the brushes 36, 37, 38 by means of the drive device 32. The brush support 40 hereby rotates about a central brush axis 44. In this way, the brushes 36, 37, 38 rotate about the brush axis 44, wherein the brushes 36, 37, 38 perform a rotation about their respective own axis under the action of the gearing.

The brushes 36, 37, 38 each have cleaning bristles 46 for placing against the wheel 16.

In addition, the brush device 32 comprises a distribution device 48 for cleaning liquid. The distribution device 48 comprises, for example, at least one spray arm 50 with a nozzle 52 arranged thereon. Cleaning liquid, in particular water, which is applied to the distribution device 48, may be directed at the wheel 16 by way of the nozzles 52 for increasing the cleaning effect.

The advancing device 34 comprises a holding device 54 and a displacement device 56. The displacement device 56 and the drive device 42 are controllable, for example, by a control device 58, which is a constituent part of the wheel washing apparatus 30 or preferably a constituent part of the vehicle washing installation 10 for controlling the rest of its functions and operations.

As can be seen in particular in FIGS. 2 and 4, the holding device 54 comprises a first holding part 60 and a second holding part 62 arranged at a distance therefrom. The holding part 60 serves to mount the brush device 32 and the drive device 42. The brush device 32 and the drive device 42 are fixed on mutually averted sides on the holding part 60. The brush device 32 may hereby, of course, carry out the rotational movement about the brush axis 44 brought about by the drive device 42.

The holding part has a substantially plate-shaped middle section 64 and lateral sections 65 on mutually averted sides of the middle section 64. For example, the holding part 60 is made by means of an edged sheet metal part.

While the holding part 60 is arranged on a first side of the holding device facing toward the brush device 32, the holding part 62 is arranged on an opposite side of the holding device 54, remote from the brush device 32. The wheel washing apparatus 30 is fixed on the support device 26 of the washing gantry by way of the holding part 62. The second holding part 62 presently comprises a middle section 66 and lateral sections 67 on mutually opposite sides of the middle section 66. For example, the holding part 62 is made as an edged sheet metal part.

In the present case, the holding part 62 has two projections 68 of tongue-like configuration on the respective lateral section 67 in the direction of the holding part 60. The lower projection 70 is hereby longer than the upper projection 68. This may also be different, however. The holding part 62 could also be configured without projections 68, 70.

In order to guide the movement of the brush device 32 from the rest position into the at least one use position, the advancing device 34 comprises a guide device 72. The guide device 72 is presently formed by the holding device 54.

In particular, the guide device 72 comprises two joint arrangements 74, 76. The joint arrangements 74, 76 are of functionally identical configuration. Therefore, identical reference numerals are used for the components of the joint arrangements 74, 76. In the following, substantially the joint arrangement 74 will be discussed, wherein the statements apply correspondingly to the joint arrangement 76.

The joint arrangement 74 comprises at least one scissor joint and presently two scissor joints 78, 80. The scissor joints 78, 80 are arranged in series, such that the guide device 72 as a whole forms a scissor track assembly 82.

The scissor joint 78 comprises joint members 84, 86 which are pivotable relative to each other and are connected to each other cross-wise. The joint member 84 is articulated on the projection 68. The joint member 86 is not articulated on the projection 70. For this purpose, a further joint member 88 of the joint arrangement 74 is provided, which is articulated on the projection 70 and on the joint member 86.

The scissor joint 80 comprises joint members 90, 92 which are pivotable relative to each other and are connected to each other cross-wise. The joint member 90 is articulated on the joint member 86 on the side remote from the joint member 88. Moreover, the joint member 90 is articulated on the holding part 60 by way of a further joint member 94 of the joint arrangement 74. The joint member 94 is accordingly articulated on the holding part 60 and on the joint member 90.

The joint member 92 is articulated on the joint member 84 on the side remote from the projection 68. With the side remote therefrom, the joint member 92 is articulated on the holding part 60.

For reinforcing the guide device 72, the mutually corresponding joint members 84, 86, 90, and 92 of the joint arrangements 74, 76 are connected to each other by way of a respective connecting member 96. The respective combination of joint members 84, 86, 90, 92 and the corresponding connecting member 96 is hereby bracket-shaped or U-shaped (FIG. 2).

The displacement device 56 comprises a pneumatically or hydraulically actuateable piston-cylinder unit 98 with a first end which is formed by the cylinder and a second end which is formed by the piston. The piston-cylinder unit 98 is held with the first end on the holding part 62, in particular the middle section 66 thereof. The second end of the piston-cylinder unit 98 is coupled to the joint arrangements 74, 76. A coupling member 100 is provided for this purpose. The coupling member 100 is presently of bracket-shaped configuration and is articulated on joint members of the joint arrangements 74, 76. These are the joint members 90. It would also be possible for the displacement device 56 to engage only on one of the joint arrangements 74, 76. An engagement on the holding part 60 is also conceivable.

The advancing device 34 further comprises at least one restoring element which acts counter to the piston-cylinder unit 98 of the displacement device 56. Presently, a plurality of restoring elements 102 in the form of spring elements 104 are provided. The spring elements 104 are configured as coil springs acting by tensile force. The spring elements 104 engage on two joint members of the joint arrangements 74, 76 that are moveable relative to each other. Presently, two spring elements 104 engage on the joint members 84, 90 of each joint arrangement 74, 76. However, they could hereby also be different joint members.

The wheel washing apparatus 30 as a whole has a compact design. The construction is hereby relatively lightweight and robust at the same time.

The piston-cylinder unit 98, the drive device 42, and the spring elements 104 are arranged between the joint arrangements 74, 76, which is beneficial to the compact design.

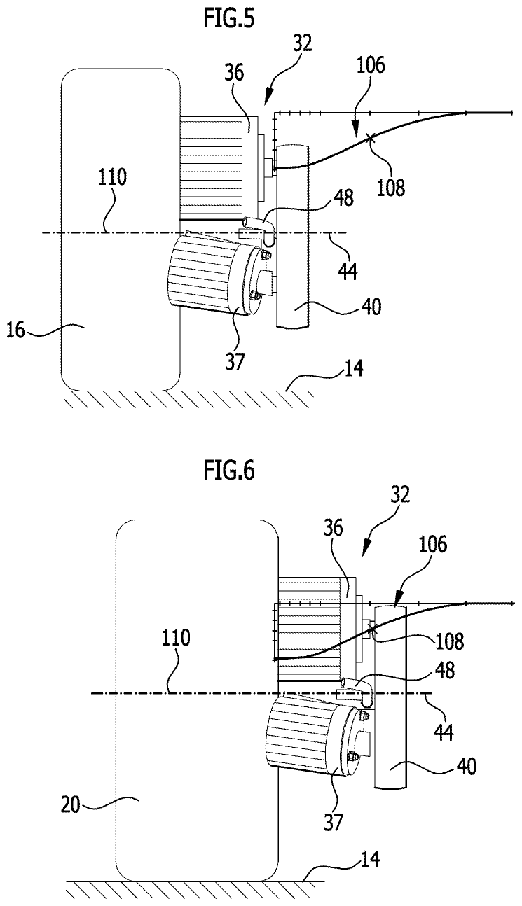

The functioning of the wheel washing apparatus 30 and the vehicle washing installation 10, and the performance of a method in accordance with the invention are described below with reference in particular to FIGS. 3 to 6. FIGS. 3 to 5 depict for example the cleaning of the wheel 16 of the motor vehicle 12, whereas FIG. 6 shows for example the cleaning of the wheel 20 of the motor vehicle 18.

The brush device 32 may adopt a rest position depicted in FIG. 3, when the wheel washing apparatus 30 is not in use. When the piston is retracted, the piston-cylinder unit 98 adopts a shortened configuration. The scissor joints 78, 80 are retracted such that the brush device 32 is positioned as closely to the holding part 62 as possible. The brush device 32 may thereby be stored in a space-saving way.

For transferring the brush device 32 from the rest position into a use position near the wheel, the piston-cylinder unit 98 is extended. The holding device 54 is hereby deformed by pivoting the joint members relative to each other. The scissor joints 78, 80 are extended and the brush device 32 brought to a greater distance from the holding part 62.

The movement of the brush device does not take place rectilinearly. This is because the scissor track assembly 82 is not only lengthened, but rather also its inclination varies in dependence on the length of the scissor track assembly 82. The cause of this is the articulation of the scissor joint 78 on the holding part 62 by way of the joint member 88 and the articulation of the scissor joint 80 on the holding part 60 by way of the joint member 94.

This leads to the brush device 32 being moveable along a trajectory 106 commencing from the rest position to a maximally extended use position. The brush device 32 is thereby lowered upon moving in the direction of the wheel 16. The movement of the brush device 32 does not take place rectilinearly, but rather arcuately. FIGS. 3, 5, and 6, and FIGS. 7, 9, 10, and 11 for the embodiments explained in the following also show schematically a coordinate system for illustrating the course of the trajectory 106.

Depending on how far the brush device 32 is extended, commencing from the rest position into the use position, until the cleaning bristles 46 contact the wheel, the brush device 32 entirely or only partially traverses the trajectory 106 during the advancement. This depends on the position of the wheel relative to the wheel washing apparatus 30. Furthermore, whether the brush device 32 is oriented coaxially to the wheel when the brushes 36, 37, 38 are placed against the wheel depends on the diameter of the wheel. FIGS. 3 to 5 show for example how the brush device 32 may be extended into a maximally extended use position for cleaning the wheel 16 in order to reproduce the entire course of the trajectory 106.

The advancing device 34 is configured such that the trajectory 106 along which the brush device 32 is moved has at least one inflection point 108. Presently exactly one inflection point 108 is provided. The inflection point 108 is located approximately in the region of the middle of the trajectory 106 between the rest position of the brush device 32 and its maximally extended use position. Commencing from the rest position, the brush device 32 is moveable arcuately in the direction of the supporting surface 14 up to the inflection point 108, the curvature of the concave trajectory 106 pointing in the direction of the supporting surface 14. From the inflection point 108 into the maximally extended use position, the brush device 32 is moveable arcuately along the trajectory 106, the curvature of convex trajectory 106 pointing away from the supporting surface 14.

As a whole, the trajectory 106 commencing from the rest position of the brush device 32 is approximately cosine-shaped. When moving commencing from the rest position and when transferring into the maximally extended use position, the brush device 32 is moveable approximately in parallel to the supporting surface 14 and in particular approximately horizontally.

The movement of the brush device 32 takes place in or substantially in a plane perpendicular to the supporting surface 14, in particular in a vertical plane.

It has been shown that in practice, by traversing the trajectory 106 with at least one inflection point 108, a better advancement of the brush device 32 to wheels of different diameters of motor vehicles of different widths can take place. The diameter of the wheels typically increases with increasing width of the motor vehicles, but not proportionally, thus the ratio of the diameter to the width of the motor vehicles decreases again as the width grows.

By the brush device 32 traversing the trajectory 106 upon the advancement, it can be better ensured than in the prior art that the brush device is advanced to the correct position. An advancement to the correct position, in which the brush axis 44 ideally is aligned with the wheel axis 110, is depicted in FIGS. 3 to 5 with the example of the wheel 16.

FIG. 6 shows the situation with the wheel 20 that is larger in relation to the wheel 16 and that also is arranged closer to the wheel washing apparatus 30 due to the wider motor vehicle 18. The brush device 32 hereby traverses only a portion of the trajectory 106, for example approximately up to the inflection point 108. In the case of the wheel 20, too, an advancement to the correct position takes place, in which the brush axis 44 is aligned with the wheel axis 110.

In the case of even larger wheels, the brush device 32 traverses an even smaller portion of the trajectory 106, for example not even up to the inflection point 108.

A further advantageous embodiment of the vehicle washing apparatus in accordance with the invention, attributed with the reference numeral 120, is discussed below with reference to FIGS. 7 to 10. Then, with reference to FIG. 11, it is followed by an explanation of an advantageous embodiment of a wheel washing apparatus in accordance with the invention, attributed with the reference numeral 140. Identical reference numerals are used for like or functionally equivalent features and components of the wheel washing apparatuses 30, 120, and 140. The advantages that can achieved with the wheel washing apparatus 30 can also be achieved with the wheel washing apparatuses 120, 140, such that reference is made to the preceding remarks in this regard. Only the most significant differences are discussed.

In the wheel washing apparatus 120, the advancing device 34 comprises a holding device 122, the displacement device 56, and a guide device 124.

The holding device 122 has a holding frame 126 with holding parts 128, 130. The holding part 128 corresponds to the holding part 60 and serves to secure the brush device 32. The holding part 130 extends from the holding part 128 in a direction pointing away from the brush device. The drive device 42 is held on the holding part 130 and on the holding part 128.

The guide device 124 comprises a constraining guide for the holding frame 126. The restraining guide is configured as a guide rail. Presently a total of four guide rails 132 are provided, wherein for example two guide rails 132 are arranged on each of the two sides of the holding frame 126. Of these, two guide rails 132 are shown in FIGS. 7 and 8. On the opposite side of the holding frame 126 (below the drawing plane), two further guide rails 132 are present, which cannot be seen in the drawing.

The two guide rails 132 arranged on one side are fixedly connected to each other. A guide rail 132 is fixed on the support device 26. This is schematically depicted in FIGS. 7 and 8. The cylinder of the piston-cylinder unit 98 also engages on the support device 26. An articulated connection is advantageously provided here. The opposite end of the piston-cylinder unit 98 is preferably articulatedly connected to the holding part 128.

The guide rail 132 is plate-shaped, for example, and comprises a sliding track 134. The sliding track 134 defines the course of the trajectory 106.

When the brush device 32 is advanced in the wheel washing apparatus 120, this takes place by lengthening the piston-cylinder unit 98. This leads to the holding frame 126, which engages into the guide rails 132 by means of guide members 136, being moved in the direction of the wheel and being displaced along the sliding track 134.

In the wheel washing apparatus 120, too, the guide device 124 is configured such that the trajectory 106 has at least one inflection point 108. With regard to the further characteristics of the trajectory 106, reference is made to the above remarks on the wheel washing apparatus 30.

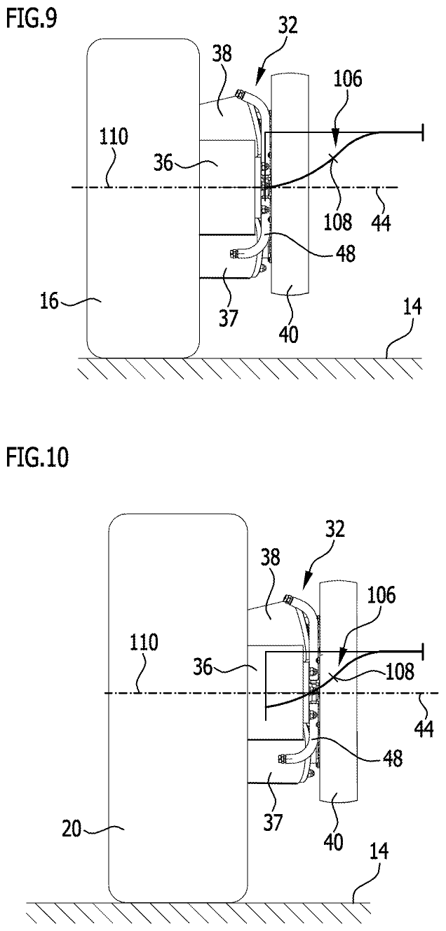

FIGS. 8 and 9 show the brush device 32 in a maximally extended use position, abutting against the wheel 16, wherein the brush axis 44 is aligned with the wheel axis 110.

FIG. 10 shows an example corresponding to FIG. 6, in which the brush device 32 is only partially extended along the trajectory 106 and is in contact with the wheel 20. Here, too, the brush axis 44 coincides with the wheel axis 110.

In the case of even larger wheels, the brush device 32 traverses an even smaller portion of the trajectory 106, for example not even up to the inflection point 108.

In the wheel washing apparatus 140 shown in FIG. 11, the advancing device 34 comprises a holding device 142 and the displacement device 56. The holding device 142 has a holding part 144 which corresponds in function to the holding parts 60 and 128, respectively. The brush device 32 and the drive device 42 are fixed on mutually opposite sides of the holding device 142.

The displacement device 56 comprises two drive units 146, 148. The drive unit 146 is fixed on the support device 26 of the washing gantry and is coupled to the drive unit 148 by way of a coupling element 150. The drive unit 148 is coupled to the holding part 144 by way of a coupling element 152. The drive units 146, 148 are controllable by the control device 58.

In the wheel washing apparatus 140, the brush device 32 may be advanced by actuating the drive units 146, 148. It is hereby also possible for the brush device 32 to be moveable along the trajectory 106 with at least one inflection point 108, commencing from the rest position into a maximally extended use position. Reference is made to the above remarks on the wheel washing apparatus 30 with regard to the further possible configuration of the trajectory 106.

The movement of the brush device 32 takes place along two directions defined by double arrows 154 and 156, wherein a movement in direction 154 may be carried out by means of the drive unit 146 and a movement in direction 156 may be carried out by means of the drive unit 148.

The directions 154, 156 are oriented at an angle to each other, and preferably perpendicularly to each other. In particular, the direction 154 may be perpendicular to the supporting surface 14 and the direction 156 may be parallel to the supporting surface 14, i.e. in particular, the directions 154, 156 are oriented vertically and horizontally, respectively.

In the wheel washing apparatus in accordance with the invention, a supply conduit 160 for a cleaning liquid may be provided. By way of the supply conduit 160, cleaning liquid may be applied to the distribution device 48, for example. With the example of the wheel washing apparatus 120, it is depicted that the supply conduit 160 is advantageously held on the holding device 122. The same may be provided for in the case of the holding device 54 of the wheel washing apparatus 30 and the holding device 142 of the wheel washing apparatus 140.

### REFERENCE NUMERALS

10 vehicle washing installation
12 motor vehicle
14 supporting surface
16 wheel
18 motor vehicle
20 wheel
22 support
24 transverse support
26 support device
30 wheel washing apparatus
32 brush device
34 advancing device
36, 37, 38 brush
40 brush support
42 drive device
44 brush axis
46 cleaning bristles
48 distribution device
50 spray arm
52 nozzle
54 holding device
56 displacement device
58 control device
60, 62 holding part
64 middle section
65 lateral section
66 middle section
67 lateral section
68, 70 projection
72 guide device
74, 76 joint arrangement
78, 80 scissor joint
82 scissor track assembly
84, 86, 88, 90, 92, 94 joint member
96 connecting member
98 piston-cylinder unit
100 coupling member
102 restoring element
104 spring element
106 trajectory
108 inflection point
110 wheel axis
120 wheel washing apparatus
122 holding device
124 guide device
126 holding frame
128, 130 holding part
132 guide rail
134 sliding track
136 guide member
140 wheel washing apparatus
142 holding device
144 holding part
146, 148 drive unit
150, 152 coupling element
154, 156 direction
160 supply conduit

1. A wheel washing apparatus for cleaning a wheel of a motor vehicle, comprising a brush device which comprises or forms at least one that is placeable against the wheel, a drive device for rotatingly driving the at least one brush, and an advancing device with which the brush device is transferable from a rest position remote from the wheel into at least one use position near the wheel, wherein the brush device is lowerable by means of the advancing device upon moving in the direction of the wheel, wherein the brush device is moveable by means of the advancing device along a trajectory having at least one inflection point upon moving from the rest position into the at least one use position.

2. The wheel washing apparatus in accordance with claim 1, wherein the brush device is moveable along a trajectory having exactly one inflection point.

3. The wheel washing apparatus in accordance with claim 1, wherein the at least one inflection point is arranged in the middle or substantially in the middle of the trajectory between the rest position and a maximally extended use position of the brush device in relation to the rest position.

4. The wheel washing apparatus in accordance with claim 1, wherein the brush device is moveable along an arcuate trajectory in at least one of the following:
commencing from the rest position to the at least one inflection point;
commencing from the at least one inflection point to a maximally extended use position of the brush device in relation to the rest position.

5. The wheel washing apparatus in accordance with claim 1, wherein the brush device is moveable along a trajectory that is substantially point-symmetrical in relation to the at least one inflection point.

6. The wheel washing apparatus in accordance with claim 1, wherein the brush device is moveable along a trajectory that is approximately cosine-shaped commencing from the rest position.

7. The wheel washing apparatus in accordance with claim 1, wherein the brush device is moveable in parallel or substantially in parallel to a supporting surface for the motor vehicle upon at least one of the following:
upon commencing from the rest position;
upon transferring into a maximally extending use position in relation to the rest position.

8. The wheel washing apparatus in accordance with claim 1, wherein the brush device is moveable in a plane oriented perpendicularly or substantially perpendicularly to a supporting surface for the motor vehicle.

9. The wheel washing apparatus in accordance with claim 1, wherein the advancing device comprises a holding device on which the brush device is fixed, and a displacement device coupled to the holding device for transferring the brush device from the rest position into the at least one use position.

10. The wheel washing apparatus in accordance with claim 9, wherein the displacement device is of at least one of electrical, mechanical, pneumatic, and hydraulic configuration.

11. The wheel washing apparatus in accordance with claim 10, wherein the displacement device comprises or forms at least one piston-cylinder unit.

12. The wheel washing apparatus in accordance with claim 9, wherein the advancing device comprises a guide device for guiding the movement of the brush device.

13. The wheel washing apparatus in accordance with claim 12, wherein the guide device comprises at least one guide rail into which at least one guide member of the holding device engages, the course of which defines the trajectory.

14. The wheel washing apparatus in accordance with claim 13, wherein at least two guide rails arranged at a distance from each other are provided, between which the holding device is arranged.

15. The wheel washing apparatus in accordance with claim 12, wherein the holding device comprises or forms the guide device.

16. The wheel washing apparatus in accordance with claim 15, wherein the guide device comprises at least one joint arrangement with joint members which are pivotable relative to each other and on which the brush device is fixed directly or indirectly by way of a holding part of the holding device.

17. The wheel washing apparatus in accordance with claim 16, wherein the joint arrangement comprises or forms at least one scissor joint, the legs of which are the joint members.

18. The wheel washing apparatus in accordance with claim 17, wherein two or more scissor joints arranged in series are present.

19. The wheel washing apparatus in accordance with claim 17, wherein the joint arrangement comprises a joint member which is articulatedly connected to one of the legs and to the brush device or the holding part.

20. The wheel washing apparatus in accordance with claim 17, wherein the joint arrangement comprises a joint member which is articulatedly connected to one of the legs and to a holding part of the holding device, by way of which holding part the holding device is fixed on a support device for placing the wheel washing apparatus on a supporting surface for the motor vehicle.

21. The wheel washing apparatus in accordance with claim 16, wherein two joint arrangements arranged at a distance from each other are provided, between which at least one of the following is arranged:
the displacement device;
the drive device for the brush device;
a restoring element which acts counter to the action of the displacement device.

22. The wheel washing apparatus in accordance with claim 21, wherein the joint arrangements are of functionally identical configuration, wherein mutually corresponding joint members of the joint arrangements are connected to each other by a connecting member.

23. The wheel washing apparatus in accordance with claim 16, wherein the displacement device is directly or indirectly coupled to at least one joint member of the at least one joint arrangement.

24. The wheel washing apparatus in accordance with claim 23, wherein two joint arrangements arranged at a distance from each other are provided as well as a bracket-shaped coupling member is provided, which is articulated on joint members of the two joint arrangements.

25. The wheel washing apparatus in accordance with claim 9, wherein the advancing device comprises at least one restoring element which acts counter to the action of the displacement device.

26. The wheel washing apparatus in accordance with claim 25, wherein the at least one restoring element is configured as a spring element.

27. The wheel washing apparatus in accordance with claim 25, wherein the guide device comprises at least one joint arrangement with joint members which are pivotable to each other and wherein the at least one restoring element biases joint members of the at least one joint arrangement relative to each other in the direction of the rest position of the brush device.

28. The wheel washing apparatus in accordance with claim 9, wherein the displacement device has two drive units for moving the holding device in two directions oriented at an angle to each other, wherein the movement of the brush device along the trajectory is controllable by controlling the drive units.

29. The wheel washing apparatus in accordance with claim 28, wherein the directions are oriented perpendicularly or substantially perpendicularly to each other.

30. The wheel washing apparatus in accordance with claim 29, wherein the directions are oriented in parallel and perpendicularly to a supporting surface for the motor vehicle.

31. The wheel washing apparatus in accordance with claim 9, wherein the drive device is fixed on the holding device.

32. The wheel washing apparatus in accordance with claim 9, wherein a supply conduit for cleaning liquid is provided, the supply conduit being held on the holding device.

33. The wheel washing apparatus in accordance with claim 1, wherein the brush device has a distribution device for a cleaning liquid.

34. A vehicle washing installation comprising at least one wheel washing apparatus for cleaning a wheel of a motor vehicle, the wheel washing apparatus comprising a brush device which comprises or forms at least one that is placeable against the wheel, a drive device for rotatingly driving the at least one brush, and an advancing device with which the brush device is transferable from a rest position remote from the wheel into at least one use position near the wheel, wherein the brush device is lowerable by means of the advancing device upon moving in the direction of the wheel, wherein the brush device is moveable by means of the advancing device along a trajectory having at least one inflection point upon moving from the rest position into the at least one use position.

35. The vehicle washing installation in accordance with claim 34, wherein the vehicle washing installation is a gantry washing installation.

36. A method for cleaning a wheel of a motor vehicle, in which a brush device, which comprises or forms at least one brush that is placeable against the wheel, is transferred by means of an advancing device from a rest position remote from the wheel into a use position near the wheel, and is thereby lowered, wherein the brush device is moved along a trajectory having at least one inflection point from the rest position into the use position.
